(19) United States
(12) Patent Application Publication
(10) Pub. No.: US 2007/0041683 A1
(43) Pub. Date: Feb. 22, 2007

(54) Tunable Optical Filter

(76) Inventor: Barrie Keyworth, Stittsville (CA)

Correspondence Address: Teitelbaum & MacLean, Suite 201, 1187 Bank Street, Ottawa, ON, K1S 3X7, CA

(21) Appl. No.: 11/463,105

(22) Filed: Aug. 8, 2006

Related U.S. Application Data
(60) Provisional application No. 60/708,382, filed on Aug. 16, 2005.

(51) Int. Cl. G02B 6/293; G02B 6/34

(52) U.S. Cl. 385/24; 385/37

(57) ABSTRACT

A tunable optical filter includes a demultiplexing device, such as an arrayed waveguide grating (AWG) or echelle grating, for separating a multiplexed optical signal into a plurality of demultiplexed optical signals. An imaging lens converges the plurality of demultiplexed optical signals to a common point on a tiltable reflector, which for example is a microelectromechanical system (MEMS) mirror. The tiltable reflector is rotated about a first axis to select which one of the demultiplexed optical signals in the plurality the tunable optical filter is tuned to. More specifically, the tiltable reflector is rotated about the first axis to select which one of the demultiplexed optical signals will be reflected with an angle that allows it to repass through the demultiplexing device and be output from an output port of the tunable optical filter.

### CROSS-REFERENCE TO RELATED APPLICATIONS

This application claims priority from U.S. provisional application No. 60/708,382 filed Aug. 16, 2005, which is hereby incorporated by reference.

### MICROFICHE APPENDIX

Not Applicable.

### TECHNICAL FIELD

The present application relates generally to tunable optical filters, and in particular, to tunable optical filters for optical communications systems and optical devices including the same.

### BACKGROUND OF THE INVENTION

Optical communication systems increasingly use wavelength-division multiplexing (WDM) to increase bandwidth. In WDM and/or dense WDM (DWDM) systems multiple optical data signals, each in a different wavelength range or channel, are combined as a single multiplexed optical signal and transmitted through a single optical waveguide.

Optical filters are useful in WDM systems for extracting a specific wavelength channel from the multiplexed optical signal. Tunable optical filters are particularly desirable because they alleviate the need to have separate optical filters for each separate wavelength channel. Some examples of tunable optical filters used in WDM systems include Fabry-Perot based tunable filters, micro-ring resonator tunable filters, Fiber Bragg grating (FBG) tunable filters, linearly variable thin film tunable filters, tilt tunable grating filters, holographic grating tunable filters, and acousto-optic tunable filters.

Currently, prior art tunable optical filters are generally limited by slow tuning speed, large power consumption, narrow tuning range, large insertion loss, poor adjacent channel isolation, bulky size and/or complex and high cost manufacturing processes. Accordingly, there is continuing interest in finding a tunable optical filter that obviates some or all of these limitations.

Moreover, there is continuing interest in tunable optical devices that use planar lightwave circuits (PLCs) and/or micro-electro-mechanical systems (MEMS), both of which provide easy integration and large scale manufacturing of optical components on a common chip.

### SUMMARY OF THE INVENTION

The instant invention relates to a tunable optical filter including a demultiplexing device that operates in reflection. In the first pass through the demultiplexing device, a multiplexed optical signal is separated into individual wavelength channels, which are output therefrom as spatially or angularly separated sub-signals. An imaging element, such as an imaging lens, is used to converge all of the sub-signals onto the same reflective surface, which then redirects all of the sub-signals back to the demultiplexing device. In the second pass through the demultiplexing device, all but one of the sub-signals is blocked due to the angular inversion provided upon reflection and the wavelength selectivity of the demultiplexing device. The unblocked sub-signal, which in one embodiment is the one with the smallest angle of incidence on the reflective surface, does not typically undergo substantial angular inversion and completes a double pass through the demultiplexing device. The unblocked sub-signal is tuned by tilting the reflective surface, thus varying the angle of incidence for each sub-signal.

The instant invention further relates to a hybrid integrated tunable optical filter that combines both PLC and MEMS technologies. In this hybrid optical device the reflective surface is a MEMS mirror and the demultiplexing device is a waveguide based device, which for example is an echelle grating or arrayed waveguide grating (AWG) integrated on a silica or semiconductor chip using planar lightwave circuit (PLC) technology. Optionally, the hybrid optical filter is integrated on the PLC with other devices, such as a passive splitter, to provide various broadcast and select architectures.

In accordance with one aspect of the instant invention there is provided a tunable optical filter comprising: a demultiplexing device for separating a multiplexed optical signal into a plurality of demultiplexed optical signals, each demultiplexed optical signal including a different wavelength channel; an imaging element for converging the plurality of demultiplexed optical signals to a common point; and a reflector disposed at the common point, the reflector tiltable about a first axis to a first position wherein one of the demultiplexed optical signals in the plurality is reflected with an angle that allows it to repass through the demultiplexing device and be output from an output port of the tunable optical filter and the remaining optical signals in the plurality are reflected with angles preventing them from repassing through the demultiplexing device and being output the output port of the tunable optical filter.

In accordance with another aspect of the instant invention there is provided a tunable optical filter comprising: an input port for receiving a multiplexed optical signal; a demultiplexing device for separating the multiplexed optical signal into a plurality of demultiplexed optical signals, each demultiplexed optical signal including a different wavelength channel; an imaging element for directing the plurality of demultiplexed optical signals to a common point; and a tiltable reflector disposed at the common point, wherein the imaging element is positioned such that each demultiplexed optical signal is incident on the reflector with a different angle and such that only one demultiplexed optical signal out of the plurality is reflected in a direction that allows it to repass through the demultiplexing device and be output an output port of the optical filter.

In accordance with another aspect of the instant invention there is provided a tunable optical filter comprising: a demultiplexing device for separating a multiplexed optical signal into a plurality of demultiplexed optical signals, each demultiplexed optical signal including a different wavelength channel; a tiltable reflector disposed for reflecting the plurality of demultiplexed optical signals in a backwards direction to the demultiplexing device; and an imaging element disposed between the demultiplexing device and the reflector, the imaging element positioned such that the demultiplexed optical signals converge at a common point on the tiltable reflector and are reflected back to the demultiplexing device along spatially inverted optical paths, the spatially inverted optical paths allowing the demultiplexing device to filter out one demultiplexed optical signal from the plurality of demultiplexed optical signals.

The term “wavelength channel”, as used herein, refers to a wavelength or range of wavelengths used to transmit a unique information signal. Each wavelength channel, which for example may include a range of wavelengths around an ITU wavelength, may or may not be evenly spaced from adjacent channels.

### BRIEF DESCRIPTION OF THE DRAWINGS

Further features and advantages of the present invention will become apparent from the following detailed description, taken in combination with the appended drawings, in which:

FIG. 1 is a schematic diagram of a tunable optical filter illustrating the general principles of the instant invention;

FIG. 2a is a schematic diagram of a tunable optical filter in accordance with an embodiment of the instant invention, wherein the demultiplexed outputs of the demultiplexing device are spatially separated;

FIG. 2b illustrates the operation of the tunable optical filter shown in FIG. 2a, wherein λ₁ is blocked;

FIG. 2c illustrates the operation of the tunable optical filter shown in FIG. 2a, wherein λ₂ is passed;

FIG. 2d illustrates the operation of the tunable optical filter shown in FIG. 2a, wherein λ₃ is blocked;

FIG. 3a is a schematic diagram of a tunable optical filter in accordance with another embodiment of the instant invention, wherein the demultiplexed outputs of the demultiplexing device are angularly separated;

FIG. 3b illustrates the operation of the tunable optical filter shown in FIG. 3a, wherein λ₁ is blocked;

FIG. 3c illustrates the operation of the tunable optical filter shown in FIG. 3a, wherein λ₂ is passed;

FIG. 3d illustrates the operation of the tunable optical filter shown in FIG. 3a, wherein λ₃ is blocked;

FIG. 4 is a schematic diagram of a tunable optical filter similar to the one shown in FIG. 2a, wherein the demultiplexing device is an AWG with spatially separated outputs;

FIG. 5 is a schematic diagram of a tunable optical filter similar to the one shown in FIG. 3a, wherein the demultiplexing device is an AWG with angularly separated outputs;

FIG. 6 is a schematic diagram of a tunable optical filter similar to the one shown in FIG. 2a, wherein the MEMS mirror provides an angle offset;

FIG. 7 is a schematic diagram of an array of tunable optical filters in accordance with the instant invention;

FIG. 8 is a schematic diagram of a demultiplexer including an array of tunable optical filters in accordance with the instant invention;

FIG. 9 is a schematic diagram of two demultiplexers formed on a same substrate, each demultiplexer including an array of tunable optical filters in accordance with the instant invention;

FIG. 10 is a schematic diagram of the demultiplexer shown in FIG. 9 coupled to a wavelength selective switch (WSS);

FIG. 11 is a schematic diagram of the demultiplexer shown in FIG. 8 coupled to a wavelength selective switch (WSS); and

FIG. 12 is a schematic diagram of a tunable optical filter in accordance with another embodiment of the instant invention, wherein the demultiplexed outputs of the demultiplexing device are angularly separated.

It will be noted that throughout the appended drawings, like features are identified by like reference numerals.

### DETAILED DESCRIPTION

Referring to FIG. 1, a schematic diagram of a tunable optical filter according to one embodiment of the instant invention is shown. The tunable optical filter 100 includes a demultiplexing device 110, an element having optical power 120, and a tiltable reflector 130.

The demultiplexing/multiplexing device 110 provides wavelength demultiplexing in the forward direction and wavelength multiplexing in the reverse direction. More specifically, the demultiplexing device is used to separate a multiplexed optical signal having n different wavelength channels into n different sub-signals, each sub-signal corresponding to a different wavelength channel. The multiplexed optical signal is launched into the demultiplexing device 110 at an first input/output end 111 thereof, and the demultiplexed optical sub-signals are output from a second input/output end 113 thereof. The demultiplexed outputs are typically spatially or angularly separated.

The element having optical power 120, which for example is an imaging element such as a lens or mirror, is used to image the demultiplexed optical sub-signals onto the tiltable reflector such that each sub-signal converges to the same point and has a unique angle of incidence on the tiltable reflector 130.

The tiltable reflector 130, which for example is a tiltable mirror, prism, or LC phase array, is used to redirect each of the sub-signals back to the demultiplexing device 110 via the element having optical power 120. Since each sub-signal has a unique angle of incidence on the reflector 130, each sub-signal will be reflected at a different angle back to the element having optical power 120. The sub-signal having an approximately zero angle of incidence will be retro-reflected back to the demultiplexing device 110 such that the forward and reverse optical paths coincide. This sub-signal will return to the demultiplexing device 110 at a position and/or with an incident angle that permits a second pass through the demultiplexing device 110. The remaining sub-signals, which have angles of incidence greater than zero, will be redirected back to the demultiplexing device 110 such that the return optical paths vary (e.g., are inverted) from the incident optical paths. As a result, the remaining sub-signals will return to the demultiplexing device 110 at positions and/or with incident angles that do not permit a second pass through the demultiplexing device 110 (i.e., will be scattered). In other words, the remaining sub-signals are blocked due to the wavelength selectivity of the demultiplexing device 110.

Advantageously, the use of the imaging element provides a simple, compact device and allows the demultiplexing device to be used in a double pass arrangement, thus reducing the number of components.

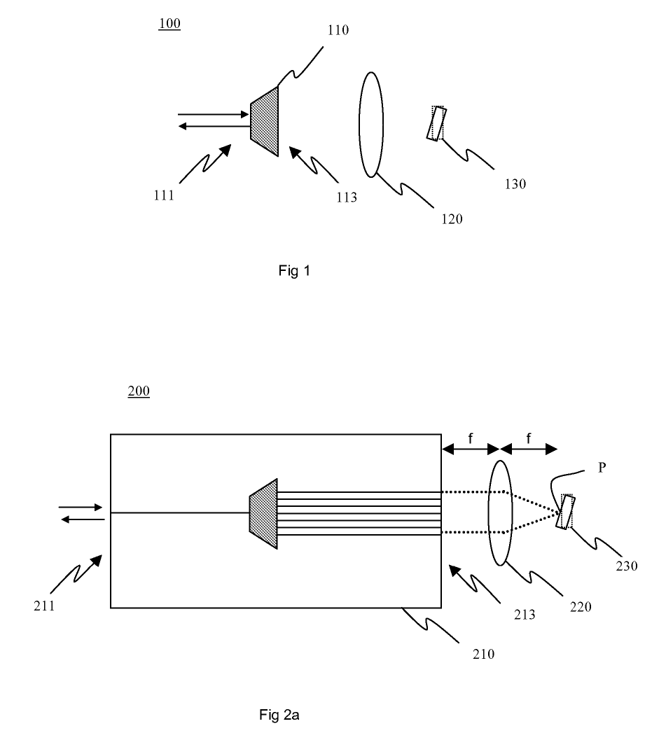

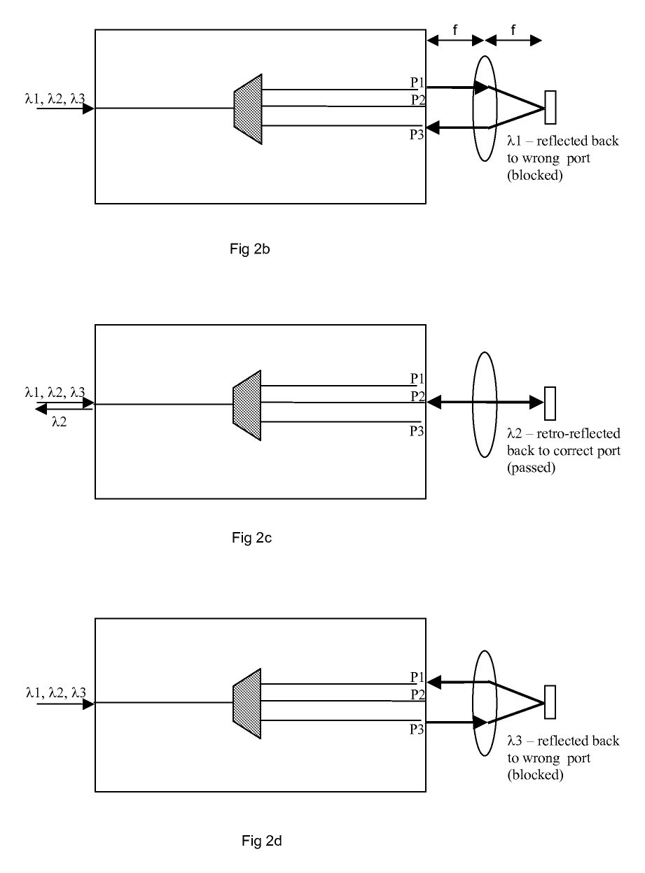

Referring to FIG. 2a, there is shown a tunable optical filter in accordance with an embodiment of the instant invention. The tunable optical filter 200 includes a demultiplexing device 210, a lens 220, and a tiltable mirror 230.

The demultiplexing device 210 is a waveguide based demultiplexing/multiplexing device, such as an arrayed waveguide grating or an echelle grating, used for wavelength demultiplexing in the forward direction and wavelength multiplexing in the reverse direction. The demultiplexing device 210, has an input port at a first input/output end 211 for receiving a multiplexed optical signal having n different wavelength channels and a second input/output end 213 for outputting n demultiplexed optical sub-signals, each demultiplexed sub-signal corresponding to a different wavelength channel and output from a different one of n spatially separated, wavelength specific output ports. Optionally, the input port at the input/output end 211 is coupled to a single-sided, dual fiber pigtail. Further optionally, an optical circulator (not shown) is provided to separate the inbound light from the outbound light.

The lens 220, which for exemplary purposes is a collimating/focusing lens having a focal length f, is optically coupled to the demultiplexing device 210 and is used to redirect all of the demultiplexed optical sub-signals output from the demultiplexing device 210 to a same point P. More specifically, the lens 220 is disposed a distance f from the demultiplexing device 210 and provides free-space imaging of the demultiplexed optical sub-signals to common point P.

The tiltable mirror 230, which for example is a MEMS mirror, is disposed a distance f from the lens 220 at point P. The mirror 230, reflects all of the sub-signals converged by the lens 220 at point P, back to the demultiplexing device 210 via the lens 220. Since each sub-signal has a unique angle of incidence on the mirror 230, each of the sub-signals is reflected back to the lens 220 at a different angle. The sub-signal with an approximately zero angle of incidence passes through the demultiplexing device 210 for a second time and is output the input port, while all of the other sub-signals are blocked due to the wavelength selectivity of the demultiplexing device 210.

The operation of the tunable optical filter illustrated in FIG. 2a is further described with reference to FIGS. 2b-d. For exemplary purposes, the multiplexed optical signal input the input port at the input/output end 211 is a telecommunication signal having wavelength channels λ₁, λ₂, and λ₃, which are separated into three sub-signals, each sub-signal corresponding to one of the wavelength channels λ₁, λ₂, and λ₃. Referring to FIG. 2b, the sub-signal including wavelength channel λ₁ is transmitted along the top optical waveguide, is output from spatially separated, wavelength specific output port P1, and is reflected at an inverted angle back to port P3. Since this sub-signal is in the incorrect wavelength range to successfully pass through the demultiplexing device 210 by entering port P3, this wavelength channel is essentially blocked. Referring to FIG. 2c, the sub-signal including wavelength channel λ₂ is transmitted along the center optical waveguide, is output from spatially separated, wavelength specific output port P2, and is retro-reflected back to port P2. Since this sub-signal is in the correct wavelength range and position to successfully pass through the demultiplexing device 210 a second time, this wavelength channel is output from the optical filter 200 from the original input port. Referring to FIG. 2d, the sub-signal including wavelength channel λ₃ is transmitted along the bottom optical waveguide, is output from spatially separated, wavelength specific output port P3, and is reflected at an inverted angle back to port P1. Since this sub-signal is in the incorrect wavelength range to successfully pass through the demultiplexing device 210 by entering port P1, this wavelength channel is essentially blocked.

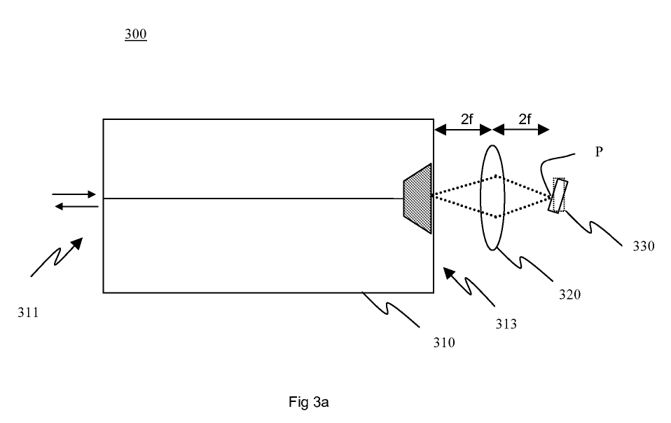

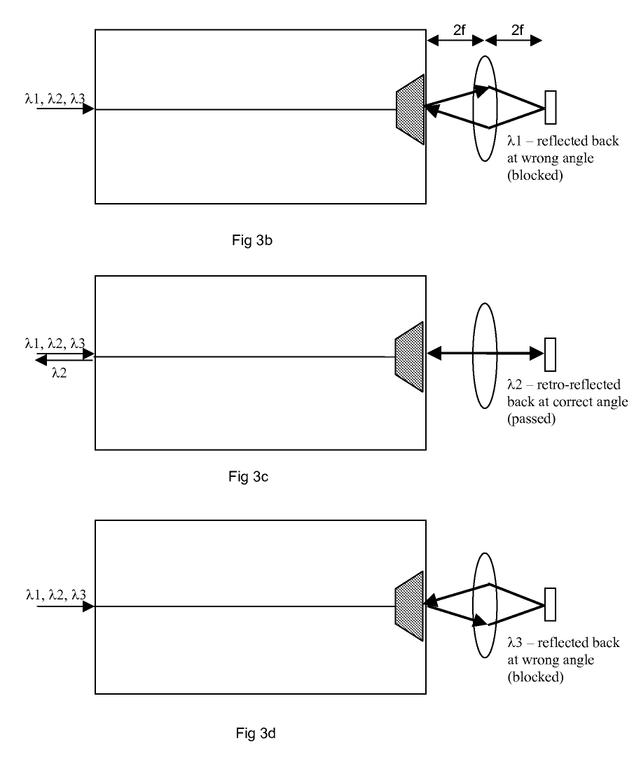

Referring to FIG. 3a, there is shown a tunable optical filter in accordance with another embodiment of the instant invention. The tunable optical filter 300 includes a demultiplexing device 310, a lens 320, and a tiltable mirror 330.

The demultiplexing device 310 is a waveguide based demultiplexing/multiplexing device, such as an arrayed waveguide grating or an echelle grating, used for wavelength demultiplexing in the forward direction and wavelength multiplexing in the reverse direction. The demultiplexing device 310, has an input port at a first input/output end 311 for receiving a multiplexed optical signal having n different wavelength channels and a second input/output end 313 for outputting n demultiplexed optical sub-signals, each demultiplexed sub-signal corresponding to a different wavelength channel and being angularly separated from the others. Optionally, the input port at the input/output end 311 of the demultiplexing device is coupled to a single-sided, dual fiber pigtail. Further optionally, an optical circulator (not shown) is provided to separate the inbound light from the outbound light.

The lens 320, which for exemplary purposes is a collimating/focusing lens having a focal length f, is optically coupled to the demultiplexing device 310 and is used to redirect all of the demultiplexed optical sub-signals output from the demultiplexing device 310 to a same point P. More specifically, the lens 320 is disposed a distance 2f from the demultiplexing device 310 and provides 1:1 free-space imaging of the demultiplexed optical sub-signals to common point P.

The tiltable mirror 330, which for example is a MEMS mirror, is disposed a distance 2f from the lens 320 at point P. The mirror 330, reflects all of the sub-signals converged by the lens 320 at point P, back to the demultiplexing device 310 via the lens 320. Since each sub-signal has a unique angle of incidence on the mirror 330, each of the sub-signals is reflected back to the lens 320 at a different angle. The sub-signal with an approximately zero angle of incidence passes through the demultiplexing device 310 for a second time, while all of the other sub-signals are blocked due to the wavelength selectivity of the demultiplexing device 310.

The operation of the tunable optical filter illustrated in FIG. 3a is further described with reference to FIGS. 3b-d. For exemplary purposes, the multiplexed optical signal input at the input/output end 311 is shown as a telecommunication signal having wavelength channels λ₁, λ₂, and λ₃, which are separated into three sub-signals, each sub-signal corresponding to one of the wavelength channels λ₁, λ₂, and λ₃. Referring to FIG. 3b, the sub-signal including wavelength channel λ₁ is transmitted in an upward direction towards the top of the lens 320 and is reflected at an inverted angle back to the output port at the input/output end 313. Since this sub-signal is in the incorrect wavelength range to successfully pass through the demultiplexing device 310 by entering at this angle, this wavelength channel is essentially blocked. Referring to FIG. 3c, the sub-signal including wavelength channel λ₂ is transmitted in a forward direction through the lens 320 and is retro-reflected back to the output port at the input/output end 313. Since this sub-signal is in the correct wavelength range and has the correct angle of incidence to successfully pass through the demultiplexing device 310 a second time, this wavelength channel is output from the optical filter 300 from the original input port. Referring to FIG. 3d, the sub-signal including wavelength channel λ₃ is transmitted in a downward direction towards the bottom of the lens 320 and is reflected at an inverted angle back to the output port at the input/output end 313. Since this sub-signal is in the incorrect wavelength range to successfully pass through the demultiplexing device 310 by entering at this angle, this wavelength channel is essentially blocked.

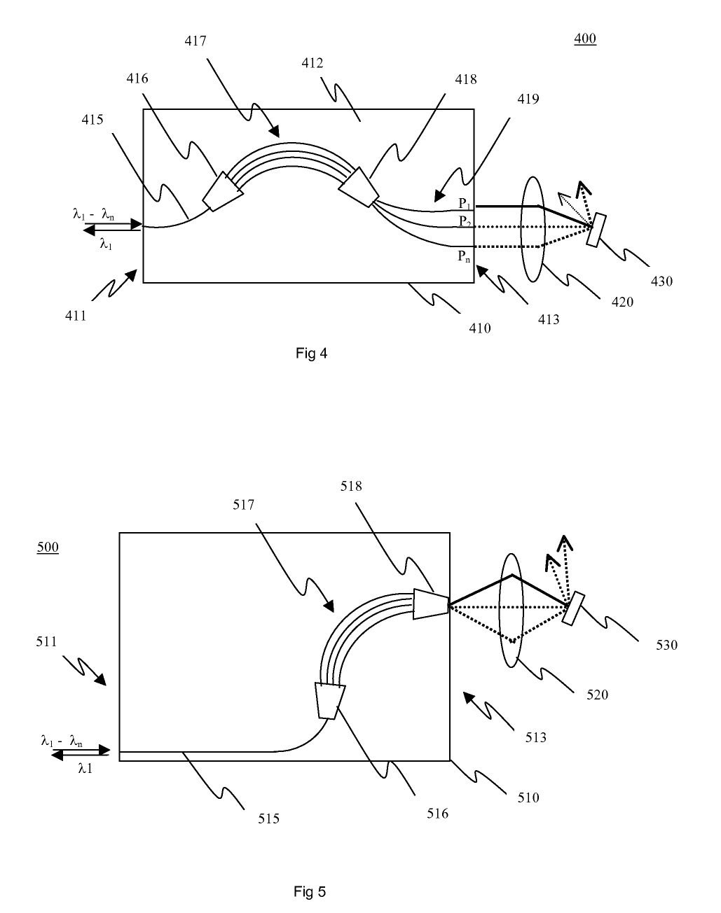

Referring to FIG. 4, there is shown a tunable optical filter in accordance with one embodiment of the instant invention. The tunable optical filter 400 includes a demultiplexing device 410, a lens 420, and a tiltable mirror 430.

The demultiplexing device 410 includes a PLC having an arrayed waveguide grating (AWG), which for example is based on a standard Gaussian AWG or flat-top AWG. The AWG includes first 416 and second 418 slab waveguides coupled by an array of waveguides having differing lengths 417 (i.e., a phased array). An input waveguide 415, which is optically coupled to an input port at the first input/output end 411 of the PLC, is used for receiving a multiplexed optical signal having n different wavelength channels. A plurality of output waveguides 419, which are optically coupled to n spatially separated, wavelength specific output ports disposed at the second input/output end 413 of the PLC, are used for outputting the n demultiplexed optical sub-signals, each demultiplexed sub-signal corresponding to a different wavelength channel. The waveguides 415 and 419 are typically formed as single mode optical waveguides embedded on the PLC substrate. Optionally, the input port at the input/output end 411 of the PLC is coupled to a single-sided, dual fiber pigtail. Further optionally, an optical circulator (not shown) is provided to separate the inbound light from the outbound light.

The lens 420, which for exemplary purposes is a collimating/focusing lens having a focal length f, is optically coupled to the PLC substrate 412 and is used to redirect all of the demultiplexed optical sub-signals output from the spatially separated, wavelength specific output ports, to the same point. More specifically, the lens 420 is disposed a distance f from the n spatially separated, wavelength specific output ports and provides free-space imaging of the demultiplexed optical sub-signals to the common point.

The tiltable mirror 430, which for example is an electrostatically actuated MEMS mirror, is disposed a distance f from the lens 420 at the common point. The mirror 430, reflects all of the sub-signals converged by the lens 420 at the common point, back to the demultiplexing device 410 via the lens 420. Since each sub-signal has a unique angle of incidence on the mirror 430, each of the sub-signals is reflected in a backwards direction at a different angle. Tuning is achieved by rotating the tilting mirror about a first axis (tilting in the direction of dispersion) to select the predetermined sub-signal chosen to have approximately normal incidence (i.e., shown to be the sub-signal corresponding to wavelength channel λ₁), and thus pass through the filter. Optionally, the tilting mirror is rotatable about a second axis (tilting orthogonal to the direction of dispersion) to vary the efficiency by which light is coupled back to the AWG waveguides, thus providing variable optical attenuation of the predetermined sub-signal and/or hitless operation of the tunable optical filter. With respect to the latter, hitless operation is achieved by rotating the mirror about the second axis to an attain an orientation that provides zero coupling efficiency as the mirror is rotated about the first axis to select the predetermined sub-signals, thus displaying no transmission between target wavelength channels.

Advantageously, this hybrid integrated device benefits from the high tuning speed and low power consumption offered by MEMS technology, and the compactness, reliability, and reduced fabrication and packaging costs associated with PLC technology. Moreover, since AWGs can exhibit non-adjacent channel isolation greater than 40 dB, and since the angular inversion provided by the mirror results in all channels (except for the unblocked sub-signal) to be offset by a minimum of two ports, the tunable optical filter in accordance with this embodiment of the instant invention provides good adjacent channel isolation.

Referring to FIG. 5, there is shown a tunable optical filter in accordance with one embodiment of the instant invention. The tunable optical filter 500 includes a demultiplexing device 510, a lens 520, and a tiltable mirror 530.

The demultiplexing device 510 includes a PLC having an arrayed waveguide grating (AWG), which for example is based on a standard Gaussian AWG or flat-top AWG. The AWG includes first 516 and second 518 slab waveguides coupled by an array of waveguides having differing lengths 517 (i.e., a phased array). An input waveguide 515, which is optically coupled to an input port at the first input/output end 511 of the PLC, is used for receiving a multiplexed optical signal having n different wavelength channels. An endface 513 of the PLC, which conveniently shares an endface with the second slab waveguide 518, includes an output port for launching n angularly separated, demultiplexed optical sub-signals, each angularly demultiplexed sub-signal corresponding to a different wavelength channel. Notably, the demultiplexed outputs are continuously dispersed in angle, and do not propagate through discrete output waveguides. The waveguide 515 is typically formed as single mode optical waveguide embedded on the PLC substrate. Optionally, the input port at the input/output end 511 of the PLC is coupled to a single-sided, dual fiber pigtail. Further optionally, an optical circulator (not shown) is provided to separate the inbound light from the outbound light.

The lens 520, which for exemplary purposes is a collimating/focusing lens having a focal length f, is optically coupled to the PLC substrate 512 and is used to redirect all of the demultiplexed optical sub-signals output from the AWG to the same point. More specifically, the lens 520 is disposed a distance 2 f from the n spatially separated, wavelength specific output ports and provides free-space 1:1 imaging of the angularly demultiplexed optical sub-signals at the common point.

The tiltable mirror 530, which for example is an electrostatically actuated MEMS mirror, is disposed a distance 2 f from the lens 520 at the common point. The mirror 530, reflects all of the sub-signals converged by the lens 520 at the common point, back to the demultiplexing device 510 via the lens 520. Since each sub-signal has a unique angle of incidence on the mirror 530, each of the sub-signals is reflected in a backwards direction at a different angle. Tuning is achieved by rotating the tilting mirror about a first axis (tilting in the direction of dispersion) to select the predetermined sub-signal chosen to have approximately normal incidence (i.e., in this case the sub-signal corresponding to wavelength channel λ₁), and thus pass through the filter. Optionally, the tilting mirror is rotatable about a second axis (tilting orthogonal to the direction of dispersion) to vary the efficiency by which light is coupled back to the AWG waveguides, thus providing variable optical attenuation of the predetermined sub-signal and/or hitless operation of the tunable optical filter. With respect to the latter, hitless operation is achieved by rotating the mirror about the second axis to attain an orientation that provides zero coupling efficiency as the mirror is rotated about the first axis to select the predetermined sub-signals, thus displaying no transmission between target wavelength channels.

Advantageously, this hybrid integrated device benefits from the high tuning speed and low power consumption offered by MEMS technology, and the compactness, reliability, and reduced fabrication and packaging costs associated with PLC technology. Moreover, since AWGs can exhibit non-adjacent channel isolation greater than 40 dB, and since the angular inversion provided by the mirror results in all channels (except for the unblocked channel) to be offset by a minimum of two ports, the tunable optical filter in accordance with this embodiment of the instant invention provides good adjacent channel isolation. Furthermore, since the AWG provides angular wavelength dispersion, without using separate output waveguides, it is possible to provide an athermal tunable optical filter. For example according to one embodiment, temperature dependence is calibrated out using the MEMS angle.

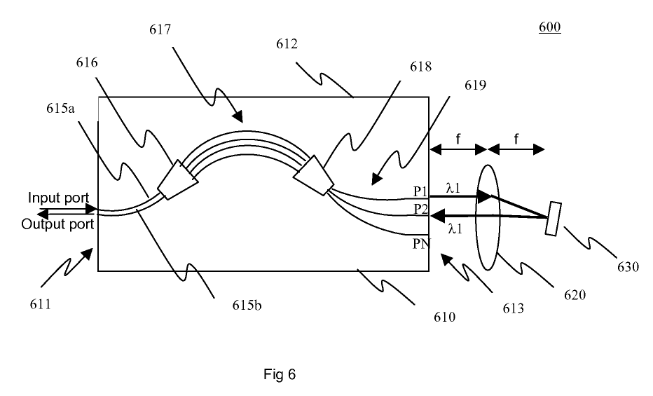

Referring to FIG. 6, there is shown a tunable optical filter in accordance with another embodiment of the instant invention. The tunable optical filter 600 includes a demultiplexing device 610, a lens 620, and a tiltable mirror 630.

The demultiplexing device 610 includes a PLC having an arrayed waveguide grating (AWG), which for example is a standard Gaussian AWG or flat-top AWG. The AWG includes first 616 and second 618 slab waveguides coupled by an array of waveguides having differing lengths 617 (i.e., a phased array). The AWG also includes a first waveguide 615a, which is optically coupled to an input port at the first input/output end 611 of the PLC, a second waveguide 615b, which is optically coupled to an output port at the first input/output end 611 of the PLC, and a plurality of output waveguides 619, which are optically coupled to a plurality of spatially separated, wavelength specific output ports disposed at the second input/output end 613 of the PLC. The waveguides 615a, 615b, and 619 are typically formed as single mode optical waveguides embedded on the PLC substrate. Optionally, input 615a and output 615b optical waveguides are coupled to input and output optical fibers (not shown), respectively.

The lens 620, which for exemplary purposes is a collimating/focusing lens having a focal length f, is optically coupled to the PLC substrate 612 and is used to redirect all of the spatially demultiplexed optical sub-signals output from the AWG to the same point. More specifically, the lens 620 is disposed a distance f from the plurality of spatially separated, wavelength specific output ports and provides free-space imaging of the demultiplexed optical sub-signals to the common point.

The tiltable mirror 630, which for example is an electrostatically actuated MEMS mirror, is disposed a distance f from the lens 620 at the common point. The mirror 630, reflects all of the sub-signals converged by the lens 620 at the common point, back to the demultiplexing device 610 via the lens 620. Tuning is achieved by rotating the tilting mirror about a first axis (tilting in the direction of dispersion) to select a predetermined sub-signal chosen to complete a double-pass through the demultiplexing device 610. Optionally, the tilting mirror is rotatable about a second axis (tilting orthogonal to the direction of dispersion) to vary the efficiency by which light is coupled back to the AWG waveguides, thus providing variable optical attenuation of the predetermined sub-signal and/or hitless operation of the tunable optical filter. With respect to the latter, hitless operation is achieved by rotating the mirror about the second axis to an attain an orientation that provides zero coupling efficiency as the mirror is rotated about the first axis to select the predetermined sub-signal(s), thus displaying no transmission between target wavelength channels.

In operation, a multiplexed optical signal having wavelength channels λ₁, λ₂, and λ₃ is launched into the first waveguide 615a. As the multiplexed optical signal is transmitted through the array of waveguides 617, it experiences interference and is output as demultiplexed optical sub-signals corresponding to λ₁, λ₂, and λ₃ from spatially separated output ports P1, P2, and P3, respectively. These spatially demultiplexed sub-signals are imaged by the lens 620 on the mirror 630 at a same common point. The mirror 630 is oriented such that one sub-signal (i.e., corresponding to λ₁) is shifted by one of more ports (e.g., from P1 to P2) and is transmitted through the demultiplexing device and output from optical waveguide 615b. The remaining sub-signals (i.e., corresponding to λ₂ and λ₃) are blocked by the AWG.

Notably, the unblocked sub-signal is not retro-reflected in this embodiment. Rather, an intentional offset is applied to the mirror angle so that the unblocked sub-signal is shifted by one or more ports (e.g., illustrated as a shift from P1 to P2 in FIG. 6). The intentional offset applied to the mirror angle is selected in dependence upon the offset between the input 615a and output 615b waveguides, and such that the unblocked wavelength is output the second waveguide 615b rather than the first waveguide 615a. Conveniently, the blocked wavelengths are reflected in a backwards direction such that they are not transmitted through output waveguide 615b.

Advantageously, this hybrid integrated device benefits from the high tuning speed and low power consumption offered by MEMS technology, and the compactness, reliability, and reduced fabrication and packaging costs associated with PLC technology. Since a typical AWG can exhibit non-adjacent channel isolation greater than 40 dB, the tunable optical filter in accordance with this embodiment of the instant invention also provides high adjacent channel isolation. Moreover, the intentional offset angle applied to the mirror allows the demultiplexed optical sub-signal to be output from the offset output port at the input/output end 611, thus obviating the need for an optical circulator.

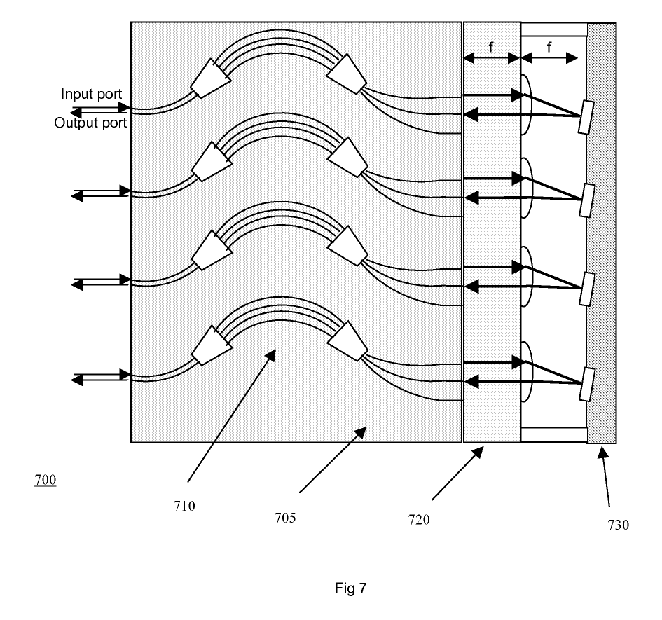

Further advantageously, the tunable optical filter illustrated in FIG. 6 is easily integrated to form an array of tunable filters. For example, referring to FIG. 7 a tunable filter in accordance with the instant invention is shown as array of tunable filters 700 having a plurality of AWGs 710 monolithically formed on a PLC substrate 705, a monolithic microlens array 720 aligned to the edge of the PLC substrate 705, and a monolithic MEMS tilting mirror array 730 aligned to the microlenses. Optionally, the monolithic microlens array 720 is replaced by a plurality of individual lenses and/or the monolithic MEMS tilting array 730 is replaced with discrete MEMS components. In either instance, each tunable filter in the array 700 is similar to and operates in a similar fashion to the tunable optical filter illustrated in FIG. 6. Of course, tunable filter arrays based on the optical filters illustrated in FIGS. 4 and 5 are also possible.

Advantageously, fabricating the plurality of tunable filters on a single PLC substrate allows the integrated AWGs to be nested, thus providing a relatively compact device with reduced manufacturing costs. Further advantageously, the tunable optical filters are easily integrated with other passive or active devices having different functionalities.

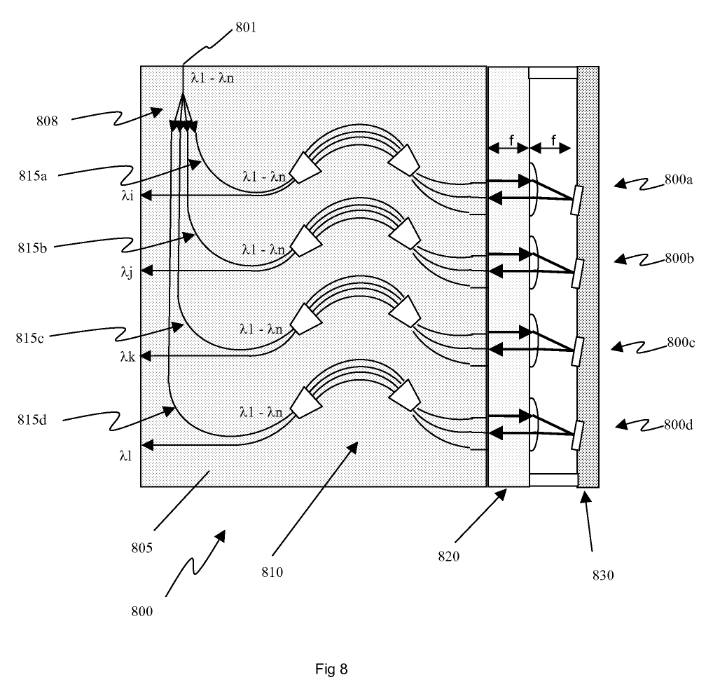

Referring now to FIG. 8, there is shown a multi-port tunable demultiplexer including a tunable filter array similar to the one illustrated in FIG. 7. The demultiplexer 800 includes a plurality of nested AWGs 810 formed on a monolithic PLC substrate 805, a monolithic microlens array 820 edge mounted to the PLC 805, and a monolithic MEMS tilting mirror array 830 aligned to the microlenses. The demultiplexer 800 also includes a 1×N waveguide splitter 808 integrated on the PLC substrate and optically coupled to each AWG. Optionally, the monolithic microlens array 820 is replaced by a plurality of individual lenses and/or the monolithic MEMS tilting array 830 is replaced with discrete MEMS components. In either case, each tunable filter 800a-d is similar to and operates in a similar fashion to the tunable optical filter described with reference to FIG. 6. Of course, multi-port tunable demultiplexers based on the optical filters illustrated in FIGS. 4 and 5 are also possible.

In operation, a multiplexed optical signal including wavelength channels λ₁-λₙ is launched into an input/output port 801 of the demultiplexer 800. The multiplexed optical signal is transmitted through the 1×N splitter 808, which separates the optical signal into N sub-signals, each sub-signal including wavelength channels λ₁-λₙ. A first sub-signal is transmitted along a first waveguide 815a to the first filter 800a. The first filter 800a is tuned to block all wavelengths but λ₁, which is output output port λᵢ. A second sub-signal is transmitted along a second waveguide 815b to the second filter 800b. The second filter 800b is tuned to block all wavelengths but λ₂, which is output output port λⱼ. A third sub-signal is transmitted along a third waveguide 815c to the third filter 800c. The third filter is tuned to block all wavelengths but λ₃, which is output output port λₖ. Finally, an n^{th} sub-signal is transmitted along an nth waveguide 815d to the nth filter 800d. The n^{th} filter is tuned to block all wavelengths but λₙ, which is output the last output port λ₁.

Advantageously, fabricating the plurality of tunable filters on a single PLC substrate allows the integrated AWGs to be nested, thus providing a relatively compact device with reduced manufacturing costs. Moreover integrating other devices with the plurality of AWGs, such as the 1×N splitter 808, provides architectures suitable for various broadcast-and-select applications.

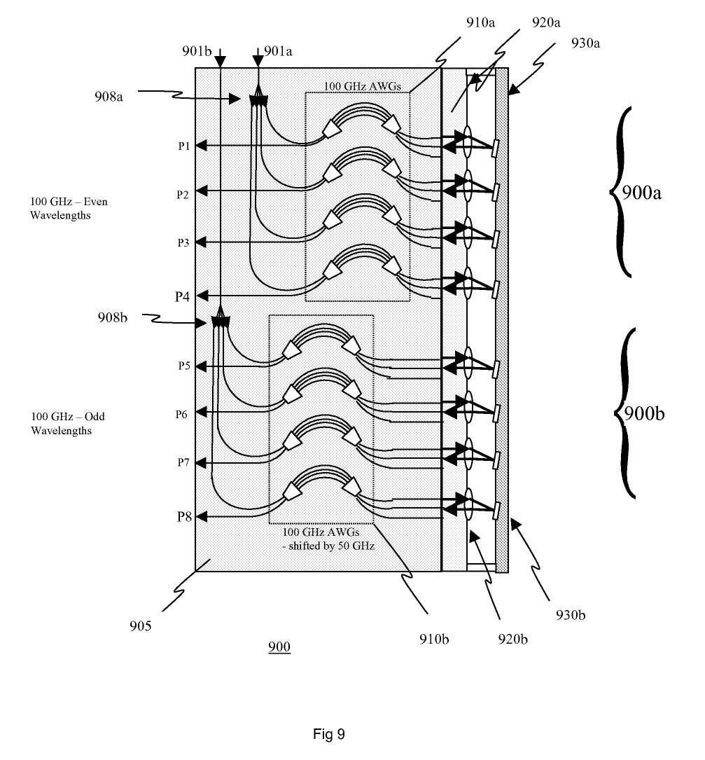

Referring now to FIG. 9, there is shown two multi-port tunable demultiplexers of the type illustrated in FIG. 8, integrated on a single PLC chip. The first demultiplexer 900a has an array of tunable filters including a plurality of nested AWGs 910a formed on the monolithic PLC substrate 905, a monolithic microlens array 920a edge mounted to the PLC 905, and a monolithic MEMS tilting mirror array 930a aligned to the microlenses. The first demultiplexer 900a also includes a 1xN waveguide splitter 908a integrated on the same PLC substrate 905 and optically coupled to each AWG in the array 910a. Optionally, the monolithic microlens array 920a is replaced by a plurality of individual lenses and/or the monolithic MEMS tilting array 930a is replaced with discrete MEMS components. In either instance, each tunable filter in the demultiplexer 900a is similar to and operates in a similar fashion to the tunable optical filter described with respect to FIG. 6. Of course, multi-port tunable demultiplexers based on the optical filters illustrated in FIGS. 4 and 5 are also possible.

The second demultiplexer 900b has an array of tunable filters including a plurality of nested AWGs 910b formed on the monolithic PLC 905, a monolithic microlens array 920b edge mounted to the PLC 905, and a monolithic MEMS tilting mirror array 930b aligned to the microlenses. The second demultiplexer also includes a 1×N waveguide splitter 908b integrated on the PLC and optically coupled to each AWG in the multiplexer 900b. Optionally, the monolithic microlens array 920b is replaced by a plurality of individual lenses and/or the monolithic MEMS tilting array 930b is replaced with discrete MEMS components. In either instance, each tunable filter in the demultiplexer 900b is similar to and operates in a similar fashion to the tunable optical filter described with respect to FIG. 6. Of course, multi-port tunable demultiplexers based on the optical filters illustrated in FIGS. 4 and 5 are also possible.

For exemplary purposes, the optical device 900 is configured to demultiplex a plurality of 100 GHz spaced even DWDM channels input at a first input port 901a of the device and a plurality of 100 GHz spaced odd DWDM channels input at a second input port 901b of the device. More specifically, the optical device is configured such that each AWG in the optical device is a 100 GHz AWG, with the plurality of AWGs in the second demultiplexer 900b being shifted by 50 GHz relative to the plurality of AWGs in the first demultiplexer 900a.

In operation, the even channel 100 GHz spaced optical signal is launched into the first input port 901a of the device. The multiplexed optical signal is transmitted through the 1×4 splitter 908a, which separates the optical signal into 4 sub-signals, each sub-signal including wavelength channels λ₂, λ₄, λ₆, and λ₈. A first sub-signal is filtered by a first optical filter tuned to λ₂ and is output port P1. A second sub-signal is filtered by a second optical filter tuned to λ₄ and is output port P2. A third sub-signal is filtered by a third optical filter tuned to λ₆ and is output port P3. A fourth sub-signal is filtered by a fourth optical filter tuned to λ₈ and is output port P4.

Similarly, the odd channel 100 GHz spaced DWDM optical signal is launched into the second input port 901b of the device. The multiplexed optical signal is transmitted through the 1×4 splitter 908b, which separates the optical signal into 4 sub-signals, each sub-signal including wavelength channels λ₁, λ₃, λ₅, and λ₇. A first sub-signal is filtered by a fifth optical filter tuned to λ₁ and is output port P5. A second sub-signal is filtered by a sixth optical filter tuned to λ₃ and is output port P6. A third sub-signal is filtered by a seventh optical filter tuned to λ₅ and is output port P7. A fourth sub-signal is filtered by an eighth optical filter tuned to λ₇ and is output port P8.

Advantageously, this optical device is suitable for expanding the port count in existing reconfigurable optical add/drop multiplexer (ROADM) nodes. In particular, this optical device has potential for expanding the colourless port count in enhanced ROADM systems. For example, the device can be coupled to an existing multiwavelength switch (MWS) that has first and second drop ports that are used to drop spaced even and odd wavelengths, respectively, to provide further demultiplexing, and hence additional tunable drop ports.

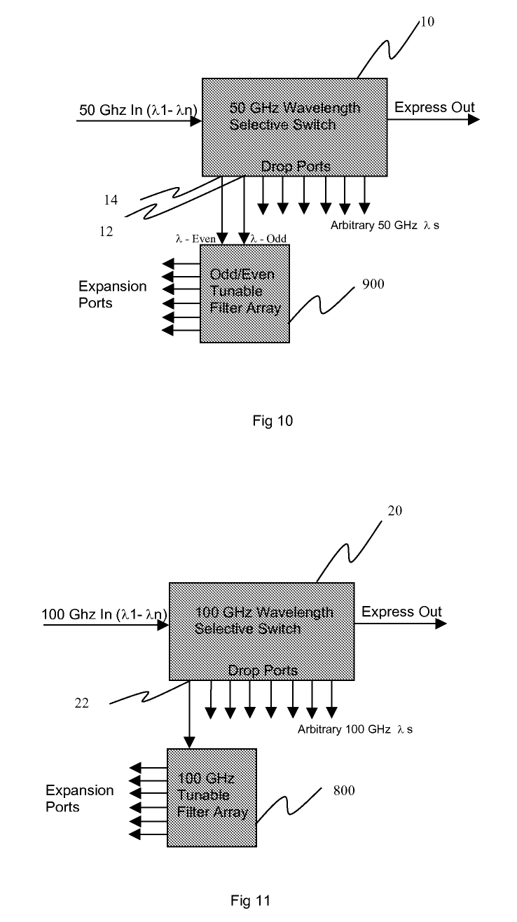

Referring now to FIG. 10, the optical device 900 is shown coupled to a MWS 10 that is used for deinterleaving a 50 GHz spaced telecommunication signal into two streams of even and odd channels at 100 GHz spacing. The MWS 10 includes a first drop port 12 to drop arbitrary 100 GHz spaced odd channels and a second drop port 14 to drop 100 GHz spaced even channels. First 12 and second 14 drop ports are coupled to first 901a and second 901b input ports, respectively.

Advantageously, when the optical device is used for port expansion as illustrated in FIG. 10, the spectral shape of the expansion ports P1-8 is dominated by the channels shape of the 50 GHz MWS, which is typically flat top. As a result, the tunable optical filter specifications are significantly relaxed, and lower loss, 100 GHz Gaussian AWGs are typically adequate. Of course, these advantages are also observed when the array of filters and MWS are configured for the same spacing.

Referring now to FIG. 11, the demultiplexer 800 illustrated in FIG. 8 is shown coupled to a MWS 20 that is used for directing a 100 GHz telecommunication signal. The MWS 20 includes a drop port 22 for dropping arbitrary 100 GHz spaced channels, which is coupled to the input port 801 of the demultiplexer 800. The addition of the demultiplexer 800 increases the number of drop ports available.

Those skilled in the art will recognize that the aforementioned embodiments are provided by way of example to illustrate the general principles of the invention and that various changes, substitutions, and alterations may be made without departing from general scope of the invention. For example, according to other embodiments the single imaging element is replaced with one or more imaging lenses or mirrors.

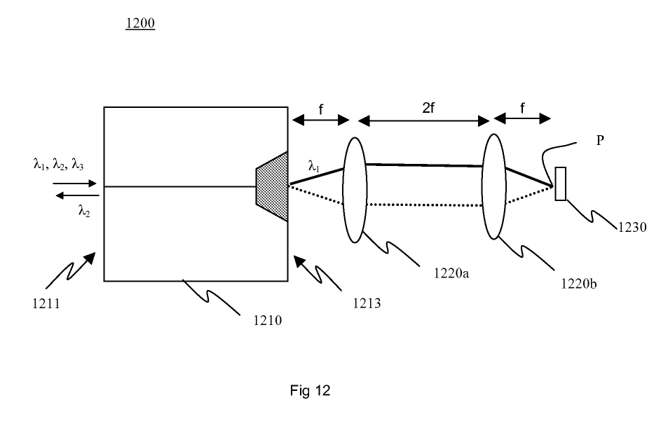

Referring to FIG. 12, there is shown a tunable optical filter in accordance with another embodiment of the instant invention. The tunable optical filter 1200 includes a demultiplexing device 1210, a first lens 1220a, a second lens 1220b, and a tiltable mirror 1230.

The demultiplexing device 1210 is a waveguide based demultiplexing/multiplexing device, such as an arrayed waveguide grating or an echelle grating, used for wavelength demultiplexing in the forward direction and wavelength multiplexing in the reverse direction. The demultiplexing device 1210 has an input port at a first input/output end 1211 for receiving a multiplexed optical signal including wavelength channels λ₁, λ₂, λ₃ and a second input/output end 1213 for outputting demultiplexed optical sub-signals, each demultiplexed sub-signal corresponding to a different one of λ₁, λ₂, and λ₃ and being angularly separated from the others. Optionally, the input port at the input/output end 1211 of the demultiplexing device is coupled to a single-sided, dual fiber pigtail. Further optionally, an optical circulator (not shown) is provided to separate the inbound light from the outbound light.

The first and second lenses 1220a/b, which for exemplary purposes are collimating/focusing lenses having a focal length f, are optically coupled to the demultiplexing device 1210 and are used to redirect all of the demultiplexed optical sub-signals output from the demultiplexing device 1210 to a same point P. More specifically, the first lens 1220a is disposed a distance f from the demultiplexing device 1210 and a distance 2f from the second lens 1220b, while the second lens 1220b is disposed a distance f from the tiltable mirror 1230. The first and second lenses 1220a/b form a 4f relay system that provides 1:1 free-space imaging of the demultiplexed optical sub-signals to common point P. Optionally, the first and second lenses are replaced by a single GRIN lens that provides the 4f relay system.

The tiltable mirror 1230, which for example is a MEMS mirror, is disposed a distance f from the lens 1220b at point P. The mirror 1230, reflects all of the sub-signals converged by the lens 1220b at point P, back to the demultiplexing device 1210 via the lenses 1220a/b. Since each sub-signal has a unique angle of incidence on the mirror 1230, each of the sub-signals is reflected back to the lens 1220b at a different angle. The sub-signal with an approximately zero angle of incidence passes through the demultiplexing device 1210 for a second time, while all of the other sub-signals are blocked due to the wavelength selectivity of the demultiplexing device 1210.

In operation, a multiplexed optical signal having wavelength channels λ₁, λ₂, and λ₃ is launched into the demultiplexing device 1210. As the multiplexed optical signal is transmitted through the demultiplexing device, it experiences interference and is output as angularly demultiplexed optical sub-signals corresponding to λ₁, λ₂, and λ₃. These angularly demultiplexed sub-signals are imaged by the lenses 1220a/b onto the mirror 1220 at a common point. The mirror 1230 is oriented such that the sub-signals corresponding to λ₁ and λ₃ are reflected and return along spatially inverted optical paths (shown for λ₁) and are blocked by the demultiplexing device. The sub-signal corresponding to λ₂ is retroreflected and returns along the straight incident path and is repassed through the AWG.

The embodiments of the invention described above are intended to be exemplary only. The scope of the invention is therefore intended to be limited solely by the scope of the appended claims.

What is claimed is:

1. A tunable optical filter comprising:
a demultiplexing device for separating a multiplexed optical signal into a plurality of demultiplexed optical signals, each demultiplexed optical signal including a different wavelength channel;
an imaging element for converging the plurality of demultiplexed optical signals to a common point; and
a reflector disposed at the common point, the reflector tiltable about a first axis to a first position wherein one of the demultiplexed optical signals in the plurality is reflected with an angle that allows it to repass through the demultiplexing device and be output from an output port of the tunable optical filter and the remaining optical signals in the plurality are reflected with angles preventing them from repassing through the demultiplexing device and being output the output port of the tunable optical filter.

2. The tunable optical filter according to claim 1, wherein the demultiplexing device includes a plurality of spatially separated output ports, each output port for transmitting one of the demultiplexed optical signals.

3. The tunable optical filter according to claim 2, wherein the imaging element includes a lens having a focal length f, and wherein the plurality of spatially separated output ports is disposed on one side of the lens at a distance f from the lens, and the reflector is disposed on an opposite side of the lens at a distance f from the lens.

4. The tunable optical filter according to claim 3, wherein the demultiplexing device includes an arrayed waveguide grating (AWG) waveguide having a plurality of laterally separated output waveguides, each output waveguide coupled to a different output port of the plurality of spatially separated output ports.

5. The tunable optical filter according to claim 1, wherein the demultiplexing device includes an output end for launching the plurality of demultiplexed optical signals along a plurality of angularly separated optical paths, each optical path corresponding to a different demultiplexed optical signal.

6. The tunable optical filter according to claim 5, wherein the imaging element includes a lens having a focal length f, and wherein the output end is disposed on one side of the lens at a distance 2f from the lens and the reflector is disposed on an opposite side of the lens at a distance 2f from the lens.

7. The tunable optical filter according to claim 6, wherein the demultiplexing device includes an arrayed waveguide grating (AWG) waveguide having a slab waveguide disposed at an edge of a substrate of the AWG at the output end, the slab waveguide for launching the plurality of demultiplexed optical signals along the plurality of angularly separated optical paths.

8. The tunable optical filter according to claim 5, wherein the imaging element includes a first lens having a focal length f and is disposed a distance 2f from a second lens having a focal length f, the first and second lenses disposed between the demultiplexing device and the reflector, the first lens disposed a distance f from the reflector, the second lens disposed a distance f from the demultiplexing device.

9. The tunable optical filter according to claim 1, wherein the reflector includes a MEMS mirror.

10. The tunable optical filter according to claim 9, wherein the MEMS mirror is tiltable about a second axis orthogonal to the first axis, wherein a rotation about the first axis selects the one demultiplexed optical signal to be output from the tunable optical filter, and wherein a rotation about the second axis selects an attenuation value of the one demultiplexed optical signal.

11. The tunable optical filter according to claim 1, wherein the reflector is tiltable about a second axis orthogonal to the first axis, wherein a rotation about the first axis selects the one demultiplexed optical signal to be output from the tunable optical filter, and wherein a rotation about the second axis selects an attenuation value of the one demultiplexed optical signal.

12. The tunable optical filter according to claim 1, wherein the demultiplexing device comprises an arrayed waveguide grating (AWG) including first and second slab waveguides disposed on opposite ends of an array of waveguides having varying lengths, the first slab waveguide coupled to an input waveguide for propagating the multiplexed optical signal and the one demultiplexed optical signal.

13. The tunable optical filter according to claim 12, wherein the angle that allows the one demultiplexed optical signal to repass through the demultiplexing device is substantially zero.

14. The tunable optical filter according to claim 1, wherein the demultiplexing device comprises an arrayed waveguide grating (AWG) including first and second slab waveguides disposed on opposite ends of an array of waveguides having varying lengths, the first slab waveguide coupled to an input waveguide for receiving the multiplexed optical signal and an output waveguide for outputting the one demultiplexed optical signal.

15. The tunable optical filter according to claim 14, wherein the angle that allows the one demultiplexed optical signal to repass through the demultiplexing device is selected such that the one demultiplexed optical signal is output via the output waveguide.

16. The tunable optical filter according to claim 15, wherein the plurality of demultiplexed optical signals are spatially separated, each demultiplexed optical signal output from the demultiplexing device via one of a plurality of spatially separated waveguides coupled to the second slab waveguide.

17. The tunable optical filter according to claim 15, wherein the plurality of demultiplexed optical signals are angularly separated, each demultiplexed optical signal output from the demultiplexing device via the second slab waveguide.

18. The tunable optical filter according to claim 1, wherein the demultiplexing device is one of a plurality of AWGs, the imaging element is one of a plurality of imaging elements, and the reflector is one of a plurality of tiltable reflectors, each AWG optically coupled to a different imaging element and reflector.

19. The tunable optical filter according to claim 18, wherein the plurality of AWGs are monolithically integrated on the same planar lightwave circuit (PLC).

20. The tunable optical filter according to claim 19, wherein the plurality of imaging elements includes a lens array and the plurality of tiltable reflectors includes a MEMS mirror array.

21. The tunable optical filter according to claim 20, comprising a 1×N optical splitter monolithically integrated on the PLC.

22. An optical device comprising a first plurality of optical filters according to claim 1.

23. An optical device according to claim 22, comprising a second plurality of optical filters according to claim 1, the first and second pluralities formed on a same planar lightwave circuit (PLC).

24. An optical device according to claim 21, comprising a first 1×N splitter formed on the PLC for transmitting a first multiplexed optical signal to each optical filter in the first plurality and a second 1×N splitter formed on the PLC for transmitting a second multiplexed optical signal to each optical filter in the second plurality.

25. An optical device according to claim 24, wherein the first and second pluralities of optical filters include arrays of 100 GHz AWGs, the 100 GHz AWGs in the first and second pluralities being shifted by 50 GHz.

26. An optical device according to claim 25, wherein the first and second pluralities of optical filters are coupled to different drop ports of a 50 GHz multiport wavelength selective switch.

27. A tunable optical filter comprising:
an input port for receiving a multiplexed optical signal;
a demultiplexing device for separating the multiplexed optical signal into a plurality of demultiplexed optical signals, each demultiplexed optical signal including a different wavelength channel;
an imaging element for directing the plurality of demultiplexed optical signals to a common point; and
a tiltable reflector disposed at the common point,
wherein the imaging element is positioned such that each demultiplexed optical signal is incident on the reflector with a different angle and such that only one demultiplexed optical signal out of the plurality is reflected in a direction that allows it to repass through the demultiplexing device and be output an output port of the optical filter.

28. A tunable optical filter according to claim 27, wherein the input port and output port are the same port, and wherein the one demultiplexed optical signal is retro-reflected from the tiltable reflector.

29. A tunable optical filter according to claim 27, wherein the input port and output ports are coupled to input and output spatially separated waveguides, respectively, and wherein the one demultiplexed optical signal is reflected with an offset angle selected in dependence upon a position of the input and output waveguides.

30. A tunable optical filter comprising:
a demultiplexing device for separating a multiplexed optical signal into a plurality of demultiplexed optical signals, each demultiplexed optical signal including a different wavelength channel;
a tiltable reflector disposed for reflecting the plurality of demultiplexed optical signals in a backwards direction to the demultiplexing device; and
an imaging element disposed between the demultiplexing device and the reflector, the imaging element positioned such that the demultiplexed optical signals converge at a common point on the tiltable reflector and are reflected back to the demultiplexing device along spatially inverted optical paths, the spatially inverted optical paths allowing the demultiplexing device to filter out one demultiplexed optical signal from the plurality of demultiplexed optical signals.
